(19) United States
(12) Patent Application Publication
(10) Pub. No.: US 2016/0371798 A1
(43) Pub. Date: Dec. 22, 2016

(54) TRAVEL CONCIERGE SYSTEM AND PROCESSES FOR BUILDING A TRAVEL ITINERARY BY A SINGLE SEARCH QUERY

(71) Applicant: Farshad Ghahramani, San Jose, CA (US)

(72) Inventor: Farshad Ghahramani, San Jose, CA (US)

(21) Appl. No.: 15/177,583

(22) Filed: Jun. 9, 2016

Related U.S. Application Data
(60) Provisional application No. 62/181,464, filed on Jun. 18, 2015.

(51) Int. Cl. G06Q 50/14; G06Q 30/06; G06F 17/30; G06Q 10/02

(52) U.S. Cl. CPC G06Q 50/14; G06Q 10/025; G06Q 30/0625; G06F 17/30867; G06F 17/30471

(57) ABSTRACT

A travel concierge system and several single search query process for building travel itineraries are disclosed. The travel concierge system and the single search query processes make it simple for a user to enter a single search term for a travel destination and receive several travel itineraries that cover all aspects of travel for the user.

### CLAIM OF BENEFIT TO PRIOR APPLICATION

This application claims benefit to U.S. Provisional Patent Application 62/181,464, entitled “Travel Concierge Web-based virtual travel agent software application with search recommendation processes,” filed Jun. 18, 2015. The U.S. Provisional Patent Application 62/181,464 is incorporated herein by reference.

### BACKGROUND

Embodiments of the invention described in this specification relate generally to automated travel itinerary and planning systems and methods, and more particularly, to a travel concierge system and a single query search process that expands a single query search to into multiple search queries to build one or more travel itineraries.

Many people who plan to travel find the process of making travel arrangements cumbersome. For example, a traveler using existing travel itinerary and planning system must make arrangements for several travel-related items by visiting one or more online systems for booking, price check, availability, venue or making phone calls, ask friends etc. In all, the user spends considerable time and effort to build an itinerary piecemeal.

For example, a user planning a trip to another city, may search for flights, hotels, local transportation, car rentals, dinner reservation and other local arrangements. This is a problem for many travelers since individual searches may not overlap with one another for search-found travel items, and therefore, must be substituted or ignored (or, in some cases, requires the user to start over with travel arrangements).

Furthermore, making travel arrangements for multiple travelers for events such as reunions, conventions etc. compounds search time and effort since each traveler will have different personal preference such as transportation, accommodation, date and time of travel etc. Thus, the complexity of planning and making travel-related arrangements will grow as the number of travelers increases.

Therefore, a solution is needed to efficiently search for travel-related items relevant to a single travel criteria (such as a travel destination) that expands a single search query into multiple search queries associated with multiple travel items for the travel plan, thereby allowing the user to derive and plan a travel itinerary via the single query instead of multiple queries.

### BRIEF DESCRIPTION

A travel concierge system and processes for building a travel itinerary by a single search query are disclosed. In some embodiments, the travel concierge system includes a network-accessible server computing device that provides a travel concierge service. In some embodiments, one or more client computing devices access the travel concierge service by connecting to the server computing device over the network. In some embodiments, the travel concierge service includes a travel concierge application with a single search query interface. Each client computing device accesses the travel concierge service over the network. When a client computing device accesses the travel concierge service, the travel concierge application provides the single search query interface to allow a user of the computing device to interact with the travel concierge service. The user interacts with the travel concierge service by inputting travel criteria in the single search query interface. In some embodiments, the travel concierge system searches for travel-related items relevant to the travel criteria.

In some embodiments, the travel concierge service includes an automated travel concierge processing service program that receives digital travel input related to a travel destination. The digital travel input is received silently by the automated travel concierge processing service program, whether or not a user interface is provided. In some embodiments, the digital travel input includes one or more of an SMS message, an RSS feed, a set of binary data associated with a voice audio clip, an image, a video, or another data format that supports a travel destination-related input.

In some embodiments, the processes for building a travel itinerary by a single search query includes a single query search process that expands a single query search specified by a user into multiple search queries to perform the search on behalf of the user and provide one or more travel itineraries.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a single search query process for determining a destination to use in building a set of travel itineraries in some embodiments.

FIG. 2 conceptually illustrates a context-aware single search query process for determining a format of content provided as travel criteria to use in determining the destination in some embodiments.

FIG. 3 conceptually illustrates a comprehensive context-aware single search query process for parsing the travel criteria content according to the determined format to build a set of travel itineraries in some embodiments.

FIG. 4 conceptually illustrates a detailed single search query process for building a set of travel itineraries in view of user preferences in some embodiments.

FIG. 5 conceptually illustrates a single search query process for building a conflict-free travel itinerary in some embodiments.

FIG. 6 conceptually illustrates a detailed single search query process for building a conflict-free travel itinerary in some embodiments.

FIG. 7 conceptually illustrates a reservation event request process for reserving a travel itinerary in some embodiments.

FIG. 8 conceptually illustrates a share/send event request process for sending or sharing a travel itinerary in some embodiments.

FIG. 9 conceptually illustrates a save event request process for saving a travel itinerary in some embodiments.

FIG. 10 conceptually illustrates detailed process for building a set of travel itineraries in some embodiments.

FIG. 11 conceptually illustrates a user preference learning and prediction process in some embodiments based on user interaction with a travel concierge system.

FIG. 12 conceptually illustrates a process for retrieving travel-related information from third party providers by third party API calls in some embodiments.

FIG. 13 conceptually illustrates a transportation API call process in some embodiments.

FIG. 14 conceptually illustrates an accommodation API call process in some embodiments.

FIG. 15 conceptually illustrates a non-interactive process for building a travel itinerary by way of a search query input file in some embodiments.

FIG. 16 conceptually illustrates personalization process for personalizing travel itinerary settings in some embodiments.

FIG. 17 conceptually illustrates a schematic view of an architecture of a travel concierge system in some embodiments.

FIG. 18 conceptually illustrates conceptually illustrates an electronic system with which some embodiments of the invention are implemented.

### DETAILED DESCRIPTION

In the following detailed description of the invention, a novel travel concierge system and processes for determining travel destination and building relevant travel itineraries by a single search query are disclosed. In describing the travel concierge system and the processes for building a travel itinerary by a single search query, numerous details, examples, and embodiments of the invention are described. However, it will be clear and apparent to one skilled in the art that the invention is not limited to the embodiments set forth and that the invention can be adapted for any of several applications in which a single search query can be used to develop a complex and multi-faceted search result set of related items or services.

In this specification, the disclosed travel concierge system and a number of disclosed travel concierge processes for determining travel destination and building relevant travel itineraries by a single search query are described at a level of detail that, in many instances, goes beyond the description of the related provisional application, which this application claims benefit to, namely, U.S. Provisional Patent Application 62/181,464, entitled “Travel Concierge Web-based virtual travel agent software application with search recommendation processes,” filed Jun. 18, 2015. However, a person skilled in the art relevant to the present invention would appreciate that the further details and descriptions provided in this specification are directly related to the descriptions of the specification for U.S. Provisional Patent Application 62/181,464, wherein a travel concierge system and processes were disclosed in such a manner as to relate the fundamental aspects of the present invention.

The need for the disclosed travel concierge system and related processes is clear by the sheer complexity of planning the many travel items needed during any extensive or even short term or nearby travel. The complexity is most simply demonstrated by example of a single traveler, who may have time considerations, cost considerations, and diet considerations at play when planning a trip. So, for example, the single traveler may consider a first expensive hotel where breakfast is included but the choice of food is limited, a second moderately-priced hotel where breakfast is offered for an additional fee but food choices are still limited, and a third budget hotel where no breakfast is provided or even offered but several food establishments are located within a mile of the hotel. When a traveler also must consider scheduling issues (timing issues), several accommodation-related issues, local transportation issues, and a plethora of other such issues, one can appreciate the need for the inventive embodiments described in this specification.

As stated above, a traveler spends considerable time and effort in searching and arranging their itinerary. Existing travel systems (itinerary, planning, booking etc.) put the burden of search on the shoulders of the traveler, forcing the traveler to visit many different websites to complete and book his or her itinerary. Thus, the overall planning and booking complexity remains an outstanding issue which none of the existing methods or systems have been able to resolve.

Embodiments of the travel concierge system and processes for building a travel itinerary by a single search query described in this specification solve such problems by providing a way such that expand a single search query into multiple search queries associated with multiple travel items for a travel plan.

For instance, from a single travel criteria such as the name of a city, relevant itineraries are built automatically as if the user had done the search and built the itinerary themselves. If none of the relevant travel itineraries are suitable to the user, further travel criteria may be input by the user for inclusion in the single search query, which the system can use to perform another search.

As an example consider a traveler who books a flight to Chicago who may also search for hotels and find a first expensive hotel, a second moderately-priced hotel, and a third budget hotel. If the user's budget is the only determining factor involved in making a decision, then the user may be able to confidently book a reservation at one of the hotels. However, most travels have several additional considerations that go into making such a decision. For instance, the user may wish to find a hotel that offers free breakfast, or free WiFi, or find a hotel that is located nearby one or more attractions, or that provides on-site parking. It does not take long before the user realizes that searching for each travel item in a manner that satisfies the many requirements, needs, or wants of the user, and is consistent with the intended dates of travel, is extremely difficult.

However, the travel concierge system described in the present specification includes back-end query management and search modules which allow the system to automatically break the single search query into multiple search queries based on the user-specified preferences and the input travel criteria. In this way, embodiments of the travel concierge system and processes for building a travel itinerary by a single search query remove several obstacles and challenges that needlessly burden the user in planning travel.

Embodiments of the travel concierge system and processes for building a travel itinerary by a single search query described in this specification differ from and improve upon currently existing options. The existing options are largely based on computer systems or software applications that are not automated or coordinated to do many search queries on behalf of the user. They leave users with the difficult tasks of identifying and utilizing several different relevant travel resources (e.g., websites, travel news feeds, travel applications, etc.) to find accommodations (e.g., hotel), local transportation options (e.g., car rentals, limo or taxi arrangements, etc.), intercity travel options (e.g., airlines, trains, etc.), and other such travel resources as needed. This is confusing, inefficient and prone to error since the user has to remember all of the travel options needed. In contrast, embodiments of the travel concierge system and processes for building a travel itinerary by a single search query removes this burden from the user so that the user does not have to manually research so many travel resources and identify a set of relevant travel resources to use in manually reserving, booking, arranging, coordinating, and otherwise planning travel options for a trip.

In addition, some embodiments of the travel concierge system and processes for building a travel itinerary by a single search query differ from currently existing mechanisms because the travel concierge system can be accessed via a user interface, such as a web browser, or via an automated travel concierge processing service program, which silently accepts travel destination input from non-user interface channels, such as a request from a user in the form of an SMS text message to receive itineraries. Furthermore, the single search query attempts to determine a travel destination from any input it receives, via non-user interface channel or via the single search query interface. Thus, some users may simply provide information that does not explicitly name the destination, but instead describes some related item, thing, event, etc., which allows the travel concierge system to identify the destination. For example, instead of provided a search query that names the intended travel city, the single search query may contain telephone area code “808”, a landmark such as “Golden Gate Bridge”, a well-known phrase “Big Apple” or the name of a professional sports team “Cowboys”. In each case the travel concierge system will determine the city to be “Honolulu”, “San Francisco”, “New York” and “Dallas” respectively.

In this specification, there are several descriptions of processes and methods that are performed by software running on a traditional computing device (e.g., computer, laptop, server, etc.) and/or on a user's mobile computing device (e.g., smartphone) in order for a user to interact with the travel concierge system to input criteria for a single search query and receive one or more travel itineraries based on the single search query. Similarly, some processes and methods are performed by software services that run silently (in the background with no user interface) on a server computer and automatically receive user-initiated input criteria (e.g., via SMS text message, RSS feed, email, etc.) to use in identifying a travel destination and, thereafter, build travel itineraries for the user to review. Additionally, at least two inventive aspects of the travel concierge system and processes for building a travel itinerary by a single search query are presented in this specification, namely, a first aspect focused on determining a travel destination based on travel criteria provided by the user and a second aspect focused on building travel itineraries based on the determined travel destination(s). In many of the examples and descriptions that follow, however, details of both aspects are described by reference to methods, processes, and/or systems. Therefore, for the purposes of the embodiments described in this specification, the word “method” is used interchangeably with the word “process”. Methods are described, therefore, by reference to example processes that conceptually illustrate one or both of the inventive aspects as process steps for determining a travel destination and for building travel itineraries based on the travel destination.

Several more detailed embodiments are described below. Section I describes several processes for determining a travel destination and for building travel itineraries based on the determined travel destination. Section II describes a cloud-network architecture of an exemplary travel concierge system. Lastly, Section III describes an electronic system that implements some embodiments of the invention.

### I. Processes for Determining a Travel Destination and for Building Travel Itineraries Based on the Travel Destination

Several embodiments of processes for determining a travel destination and for building travel itineraries based on the determined travel destination are described next. Each embodiment of a process provides steps by which a user can easily input minimal travel information or can send travel criteria by way of a non-user interface channel (such as SMS text message, RSS feed, email, etc.) and maximize the number of relevant travel itineraries that the system creates, all free of conflict and all paying due consideration to user preferences.

A. Single Search Query Processes for Determining Travel Destinations

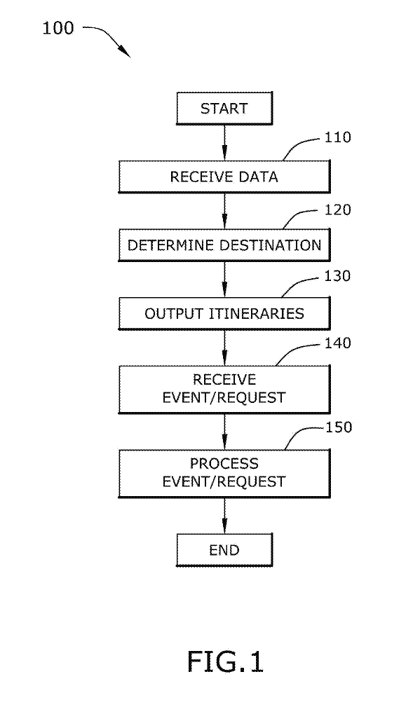

By way of example, FIG. 1 conceptually illustrates a single search query process 100 for determining a destination to use in building a set of travel itineraries in some embodiments. The single search query process 100 involves receiving travel criteria via user input at a single search query user interface or via a non-user interface channel (e.g., SMS text message, email, etc.) and then determining travel destination(s) based on the travel criteria. Therefore, the single search query process 100 may be implemented on a computing device with or without displaying a user interface. Specifically, the single search query process 100 may be, on the one hand, implemented as a travel concierge software application that which when running on a processor of the computing device displays a user interface (UI) with a single search query and a plurality of entry fields, receives travel criteria as user input in the single search box, and, based on the travel criteria, determines a destination to use in building a set of travel itineraries. Alternatively, the single search query process 100 may be implemented as an automated travel concierge processing service program that runs silently (as a background process) on a cloud server to receive digital travel criteria input (e.g., SMS messages, RSS feeds, email, etc.) related to a travel destination and, based on the digital travel criteria input, determines travel destination(s) to use in building the itineraries.

In some embodiments, the single search query process 100 starts when a user inputs travel criteria in a single search query of the travel concierge software application (or when the user sends travel criteria as a digitized message to the automated travel concierge processing service program that runs silently on the cloud server). In some embodiments, travel criteria entered into the single search query (or included in a digitized message sent to the automated travel concierge processing service program) is analyzed by a natural language processing (NLP) module that works as a background function (or separate background process) to process user input of travel criteria in real-time. In some embodiments, when the travel criteria is input by the user into a single search query user interface (but not the automated travel concierge processing service program), there is an accompanying auto-completion module to aid the user with suggestions as the user enters travel criteria into the single search query. The auto-completion module of some embodiments is an industry-standard, context-aware user interface which helps users in completing their search sentences. In some embodiments, the user interface of the auto-completion module is implemented as a drop-down box displayed beneath the search box. For example, the auto-completion module may take “Mi” and provide a drop-down box with “Miami”, “Minneapolis”, “Michigan”, “Minnesota”, “Missouri”, or “Mississippi”, but as the user continues to type characters into the single search box (e.g., “Miss”), the number of suggestions is filtered automatically, such that the only suggestions remaining are “Missouri” and “Mississippi”.

In some embodiments, the single search query process 100 receives (at 110) the data and determines (at 120) a destination of travel. As noted above, the travel criteria is related in some way to a travel destination, but need not specifically name a particular travel destination city or region, but may instead refer to the travel destination by other things which suggest a specific destination (e.g., “the Liberty Bell” suggests a travel destination of Philadelphia, Pa.). When the destination is determined, then the single search query process 100 outputs (at 130) a set of travel itineraries. The number of travel itineraries output depends on a variety of factors not limited to the determined destination. For example, user input of a “city”, a “zip code”, a “county”, a “state”, or a “district” in the search box are processed in such a manner as to search for, find, and present to the user numerous related travel options when applicable. Examples of such travel options include the cheapest airline, train, bus, carpools if the user is price conscientious, otherwise the most convenient, car rental services available, lodging information such as hotel, motel, bed-and-breakfast, RV Park, camp sites, etc., transportation from arrival place such as shuttle, limousine, taxi, bus, train, etc., transportation to departure place, etc. Based on the user's personalization, one or more venue of interest from the aforementioned section may be selected as well. More information on the data displayed follows and further details of building and outputting travel itineraries are described below by reference to the other figures.

In some embodiments, after the travel itineraries are output, the single search query process 100 receives (at 140) an event/request. For instance, the user may select one of the output travel itineraries to view in closer detail, to save for later, or to complete travel bookings and reservations. In response to the received event/request, the single search query process 100 processes (at 150) the event/request. Further details of events and requests are described below by reference to the other figures. Then the single search query process 100 ends.

The travel criteria input by the user may be context-specific and may include data that is formatted in a particular manner. Thus, to search for a particular destination, the user may provide text in alphabetical format or numerical format. For example, the single search query of the travel concierge software application may receive data input of one or more of the following textual items: a date, a zip code, a city, a state, a county, a district, telephone area code, event etc.

In some embodiments, the user can enter a venue of interest in the search query. In some embodiments, the single search query is complemented by a plurality of user-selectable fields that allow the user to choose a type of venue. Examples of the types of fields for specifying a venue include meetings such as conference or conventions, activities such as sports or social, landmarks etc.

In some embodiments, the single search query of the travel concierge software application is a context-aware user interface element. Thus, as an alternative to textual input, or in conjunction with textual user input, the user may provide non-textual input, such as an image or a video of a city as the travel criteria, or audio by vocalizing the name of a city, a zip code, an area code, a landmark, a nickname (e.g., “the big apple” for New York City), etc.

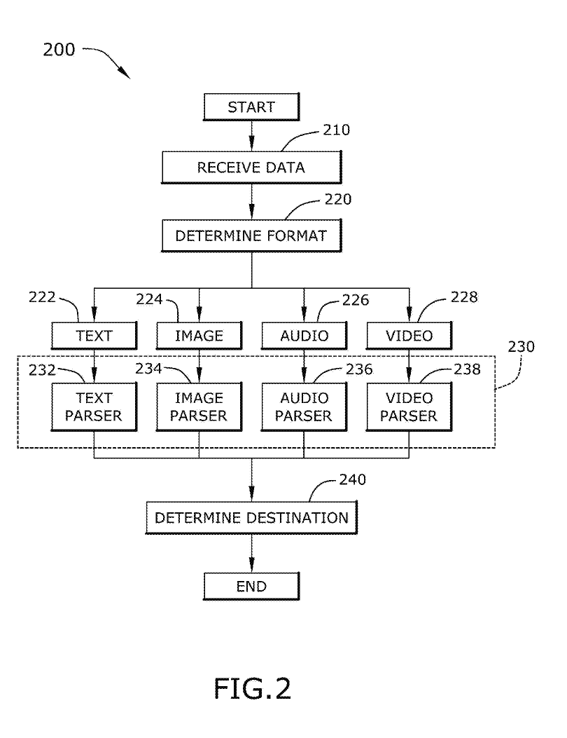

By way of example, FIG. 2 conceptually illustrates a context-aware single search query process 200 for determining a format of content provided as travel criteria to use in determining the destination in some embodiments. The context-aware single search query process 200 starts by receiving input (at 210) that in some way relates to a travel destination. Next, the context-aware single search query process 200 determines (at 220) the format which can be any of the following exemplary formats: text 222, image 224, audio 226, and video 228. These formats are understood to be only a sample of the types of data formats to identify a travel destination. A person skilled in the relevant art would appreciate the many different types of data formats which could be provided to specify a travel destination.

In some embodiments, the context-aware single search query process 200 parses (at 230) the received travel criteria according to the format of the travel criteria data. Specifically, when the context-aware single search query process 200 determines that the received travel criteria is formatted as text data, the process parses the travel criteria with a text parser 232; when context-aware single search query process 200 determines that the received travel criteria is formatted as image data, the process parses the travel criteria with an image parser 234 (or image processor); when the process 200 determines that the received travel criteria is formatted as audio data, the process parses the travel criteria with an audio parser 236 (or audio processor); when the context-aware single search query process 200 determines that the received travel criteria is formatted as video data, the process parses the travel criteria with a video parser 238 (or video processor).

After the travel criteria data is parsed according to the determined format, the context-aware single search query process 200 of some embodiments determines (at 240) the destination. Then the context-aware single search query process 200 ends.

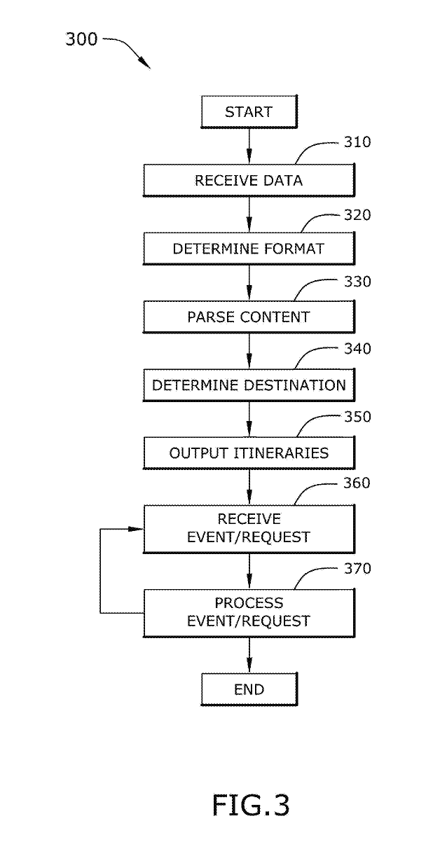

Now, putting the steps of FIGS. 1 and 2 together, one can appreciate how useful the single search query mechanism of the present disclosure is for users who make travel arrangements as simply and comprehensively as possible by way of a single resource. The combination of the steps in FIGS. 1 and 2 is shown in FIG. 3, which conceptually illustrates a comprehensive context-aware single search query process 300 for parsing the travel criteria content according to the determined format to build a set of travel itineraries in some embodiments. As shown in this figure, when the user provides data in the single search query of the travel concierge software application, the comprehensive context-aware single search query process 300 receives (at 310) the user-provided travel criteria data, determines (at 320) the format of the travel criteria data, parses (at 330) the content of the travel criteria data according to the determined format of the data, determines (at 340) the destination based on the results of parsing the travel criteria data, and outputs (at 350) a set of travel itineraries for the user to review, view in detail, select, or otherwise use in deciding on a particular itinerary. Thus, the remaining steps include any such user interactions, whereby the comprehensive context-aware single search query process 300 receives (at 360) an event or request and processes (at 370) the received event or request. Since the user may complete many actions in relation to the outputted itineraries, the comprehensive context-aware single search query process 300 may repeat the steps for receiving an event/request (at 360) and processing the received event/request (at 370) as many times as needed based on the user's interaction within the user interface of the travel concierge software application. The comprehensive context-aware single search query process 300 ends when the user stops interacting with the travel concierge software application (e.g., closes the software application).

As noted above, the travel destination can be determined when any kind of user input of travel criteria is provided, beyond the type of user input of a travel criteria that specifically calls out a travel destination city or region. The following examples demonstrate different types of travel criteria that can be provided so that a travel destination can be determined. For instance, a telephone area code, a landmark, a sports team or events such as technical, social, political etc. Other examples include a person's name (e.g., “Roland Reagan”) which may identify a travel destination closely related to the person (e.g., Simi Valley, the city in which the Ronald Reagan Presidential Library is located). A person's name can also relate to current events surrounding the person, such as travel criteria specifying “Justin Beiber” may determine upcoming concert cities. An example of a known place would be “Smithsonian”, location Washington D.C. where the museum is located. Examples of sports would be “Bengals Cowboys” where flight originating from Cincinnati to Dallas with additional itineraries in the Dallas area. Examples of a natural item/phenomenom would be “Niagara Falls” which may then determine the nearby region where there are airports (e.g., Buffalo, N.Y., Toronto, Ontario, etc.). Examples of historic would be “Pearl Harbor” which determines that Hawaii is a travel destination. Example of district would be “French Quarter” for travel to New Orleans, La., etc.

B. Building Travel Itineraries in View of User Preferences and Conflict-Free

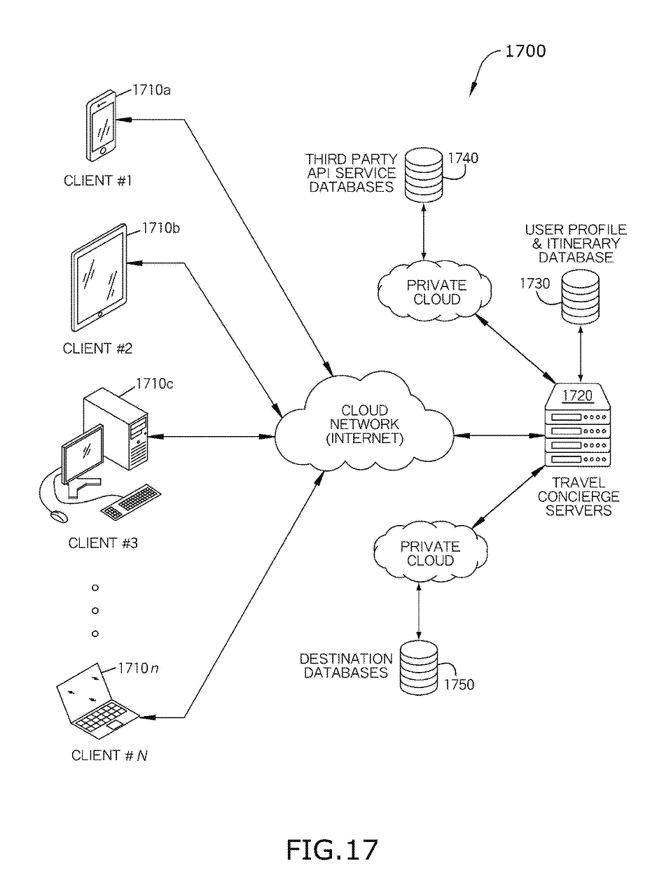

The single search query processes described above by reference to FIGS. 1-3 focus on the steps for determining the destination of travel and outputting itineraries based on the identified destination. In some embodiments, the itineraries that are created and output depend on additional information related to the particular user for whom the travel itineraries are intended to serve. For example, an itinerary for a first user who has not specified any restrictions on air travel may include daytime flights and nighttime flights (including, e.g., so-called “red-eye” flights), while an itinerary for a second user who has indicated a desire to only fly during daylight hours would not include any nighttime flights. In some embodiments, the information related to particular users is stored in a profile database of a travel concierge system, which is described below by reference to FIG. 17. Such user preferences impact the creation of itineraries for users.

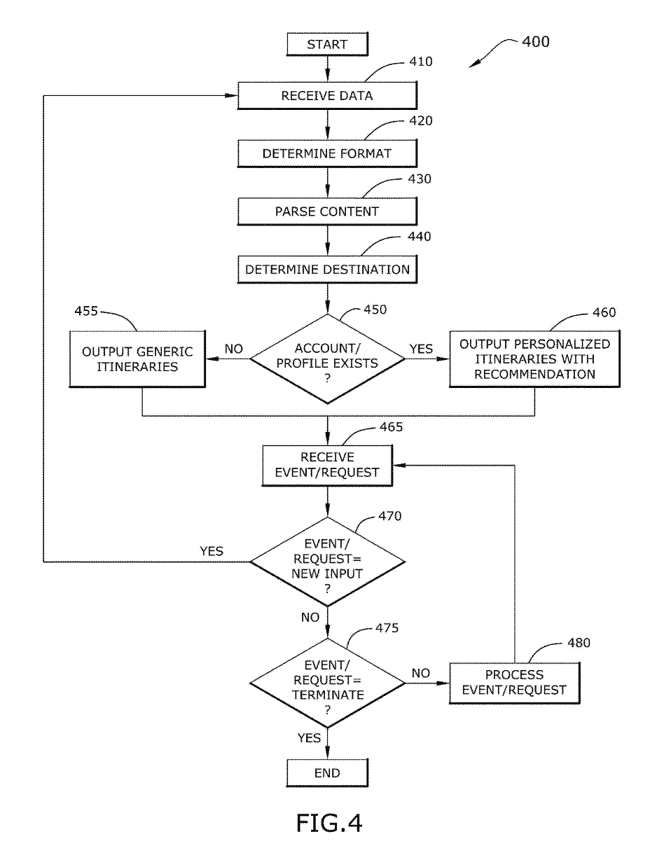

By way of example, FIG. 4 conceptually illustrates a detailed single search query process 400 for building a set of travel itineraries in view of user preferences. As shown in this figure, the detailed single search query process 400 receives (at 410) the user-provided travel criteria data, determines (at 420) the format of the travel criteria data, parses (at 430) the content of the travel criteria data according to the determined format of the data, and determines (at 440) the destination based on the results of parsing the travel criteria data.

In some embodiments, the detailed single search query process 400 determines (at 450) whether an account or profile exists for the user. The user may provide travel criteria in some cases without specifying an account or profile, in which case the detailed single search query process 400 would simply output (at 455) a set of generic itineraries that have been created based on the destination travel criteria as provided. On the other hand, when the user has an account or profile and is searching for travel itineraries when logged into the system, then the detailed single search query process 400 outputs (at 460) a set of personalized itineraries with one or more recommendations or recommended itineraries. In some embodiments, the detailed single search query process 400 provides a way for the user to view the generic set of travel itineraries even when the user is logged in and personalized travel itineraries have been created and output. In this way, the user can see all the travel itineraries relevant to the determined destination, whether or not the user filters the itineraries according to previously specified preferences and user-designated travel parameters associated with their account. In any event, the detailed single search query process 400 would highlight the set of personalized travel itineraries when the user is logged in. For example, the set of personalized travel itineraries may be more prominently displayed when output and displayed for the user to review.

After outputting the set of itineraries, the detailed single search query process 400 of some embodiments receives (at 465) an event/request. Then the detailed single search query process 400 determines (at 470) whether the received event or request constitutes new user input of travel criteria. For example, the event may be a new destination input by the user into the single search box, or the event could be related to the present destination as already determined, such as a request to save a particular itinerary, a request to view one or more of the itineraries in greater detail, etc. When the event/request is determined to be new travel criteria input by the user, the detailed single search query process 400 then returns to the step for receiving (at 410) the travel criteria data and continues through the subsequent steps as described above. On the other hand, when the event/request is not determined to be new travel criteria input, then the detailed single search query process 400 transitions to the next step of determining (at 475) whether the event/request is a termination event/request. When the event/request is not determined to be a termination event/request, the detailed single search query process 400 processes (at 480) the event/request and then transitions back to receiving (at 465) the next event/request. In some cases, the next event/request takes some time to be received. For example, the user may choose to review a particular itinerary in detail, which may take 20 minutes or more. During the time the user is reviewing the detailed information of the particular itinerary, the detailed single search query process 400 waits for the next event/request to be received. The travel concierge software application may include any of several well-known techniques for waiting, such as including a listener module which performs instructions to wait for operating system notifications of received events. In any event, the detailed single search query process 400 continues to repeat this cycle until a termination event/request is received, at which time the detailed single search query process 400 ends.

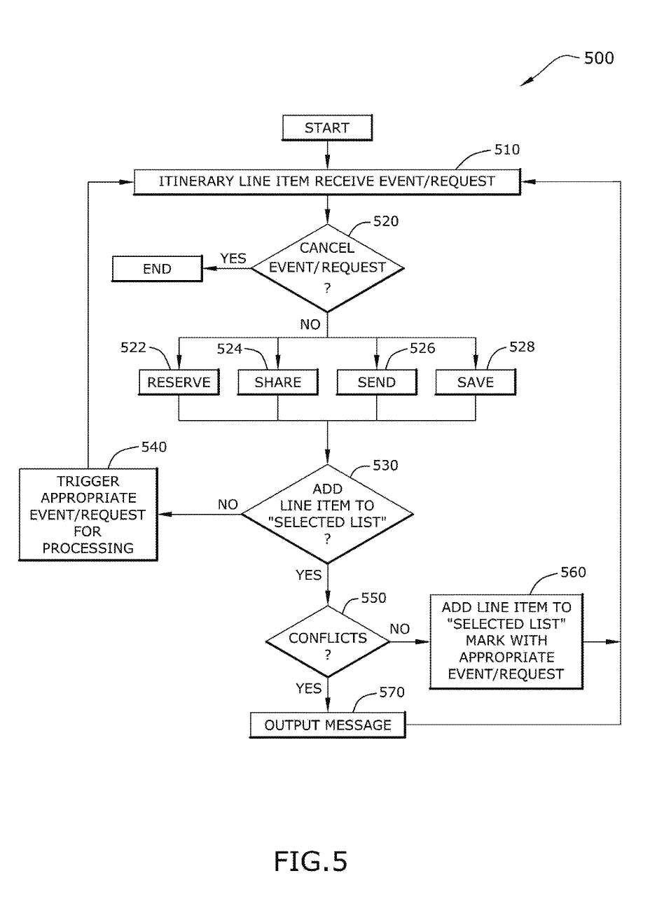

As occurs in many real-world scenarios, conflicts arise which need to be accounted for when planning any travel itinerary and making the necessary arrangements. The next two examples describe single search query processes for building conflict-free travel itineraries. Specifically, FIG. 5 conceptually illustrates a single search query process for building a conflict-free travel itinerary 500 in some embodiments. As shown in this figure, the single search query process for building a conflict-free travel itinerary 500 starts by receiving (at 510) an event/request in relation to an itinerary line item. For example, in reviewing a particular itinerary in detail, the user may select a proposed hotel to book for accommodations at the destination. The single search query process for building a conflict-free travel itinerary 500 then determines (at 520) whether the event/request is to cancel the itinerary line item request/event. For instance, the user may not wish to do anything at this time in relation to the itinerary line item. Thus, when the event/request is to cancel the itinerary line item, the process 500 ends. This simply means that the travel concierge software application may still be running and the user may still be reviewing the particular itinerary in detail, but the selected line item is no longer selected, thereby allowing the user to select other items in the particular itinerary.

On the other hand, when the event/request is not for canceling, the single search query process for building a conflict-free travel itinerary 500 then transitions to a stage for determining the event/request operation. That is, the process 500 may identify the itinerary line item event/request to be a reserve event/request 522, a share event/request 524, a send event/request 526, or a save event/request 528. A person skilled in the relevant art would appreciate that many different types of events or requests which the travel concierge software application can accommodate in carrying out the single search query processes for building a travel itinerary. Thus, the event/request examples described here (i.e., reserve 522, share 524, send 526, save 528) are not to be considered the only event/request options available for itinerary line items, but are intended to illustrate how the process 500 may work when a particular itinerary line item is selected by the user.

In some embodiments, the single search query process for building a conflict-free travel itinerary 500 then determines (at 530) whether to add the itinerary line item to a selected list of itinerary line items. For example, the user may wish to pick and choose various itinerary line items to process in a specific way, and therefore, may select multiple line items (one after another). When the itinerary line item is to be added to the selected list, the single search query process for building a conflict-free travel itinerary 500 then transitions to 550, which is described further below. On the other hand, when the process 500 determines that the itinerary line item is not to be added to the selected list, the single search query process for building a conflict-free travel itinerary 500 then triggers (at 540) an appropriate event/request for processing. That is, the process 500 triggers an event/request processing operation that corresponds to the specified event/request.

As noted above, after determining that the itinerary line item is not to be added to the selected list, the single search query process for building a conflict-free travel itinerary 500 transitions to 550 to determine whether any conflicts exist. When there are no conflicts, the single search query process for building a conflict-free travel itinerary 500 adds (at 560) the itinerary line item to the selected list and marks the itinerary line item in the list with the appropriate event/request. For example, the user may have added a hotel itinerary line item to the selected list and the event/request may be to reserve the hotel, which is marked as such in the selected list. Then the process 500 returns to 510 to receive another event/request in relation to the itinerary line item. For example, even after the hotel itinerary line item is marked in the selected list to “reserve”, the user may also wish to send the hotel itinerary line item to others (e.g., via email), share the hotel itinerary line item (e.g., in a calendar application commonly used by others, or via social media platform, etc.), or save the hotel itinerary line item (e.g., for future consideration in other travel itineraries).

On the other hand, when the user tries to add an itinerary line item to the selected list, but a conflict exists in relation to the itinerary line item, then the single search query process for building a conflict-free travel itinerary 500 outputs (at 570) a conflict warning message indicating that the conflict exists. In some embodiments, conflicting itinerary line items cannot be added to the selected list. In some other embodiments, conflicting itinerary line items are allowed to be added to the selected list, but the conflict warning message is simply stated for the user to proceed with caution.

Whether a conflict exists for any given itinerary line item or any selected event/request, the process 500 continues to repeat the steps above until the event/request that is received is a cancel event/request. Then the single search query process for building a conflict-free travel itinerary 500 ends.

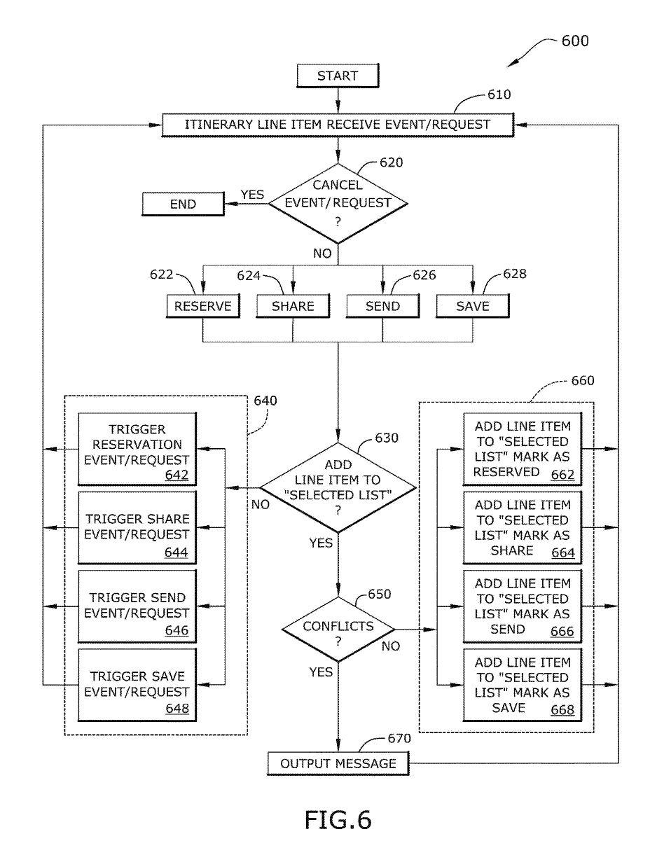

Turning now to FIG. 6, which conceptually illustrates a detailed single search query process for building a conflict-free travel itinerary 600 in some embodiments. As shown in this figure, the detailed single search query process for building a conflict-free travel itinerary 600 includes steps similar to the steps described above by reference to FIG. 5. Thus, the detailed single search query process for building a conflict-free travel itinerary 600 receives (at 610) an event/request in relation to an itinerary line item, determines (at 620) whether the event/request is to cancel the itinerary line item request/event, identifies the itinerary line item event/request to be one of a reserve event/request 622, a share event/request 624, a send event/request 626, and a save event/request 628, determines (at 630) whether to add the itinerary line item to a selected list of itinerary line items, triggers (at 640) an appropriate event/request for processing when the itinerary line item is not to be added to the selected list, determines (at 650) whether any conflicts exist when the itinerary line item is to be added to the selected list, adds (at 660) the itinerary line item to the selected list and marks the itinerary line item in the list with the appropriate event/request when no conflicts exist, and outputs (at 670) a conflict warning message when a conflict exists.

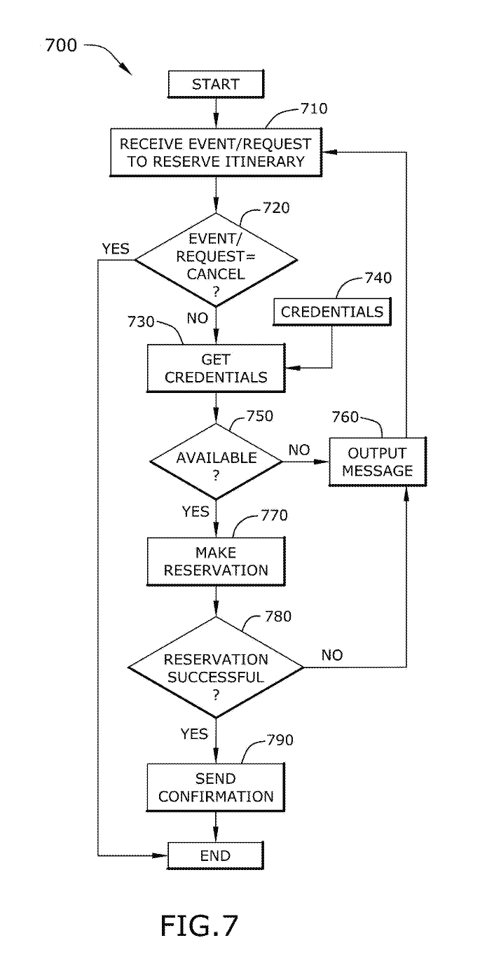

The detailed single search query process for building a conflict-free travel itinerary 600 includes specific steps in relation to triggering the appropriate event/request for processing (at 640), namely, triggering reservation event/request (at 642), triggering share event/request (at 644), triggering send event/request (at 646), and triggering save event/request (at 648). These specific steps for triggering the appropriate event/request for processing are described further below by reference to FIGS. 7-9.

The detailed single search query process for building a conflict-free travel itinerary 600 also includes specific steps in relation to adding the itinerary line item to the selected list and marking the itinerary line item in the selected list with the appropriate event/request (at 660). These steps include adding the itinerary line item in the selected list and marking as reserved (at 662), adding the itinerary line item in the selected list and marking as share (at 664), adding the itinerary line item in the selected list and marking as send (at 666), and adding the itinerary line item in the selected list and marking as save (at 668).

The detailed single search query process for building a conflict-free travel itinerary 600 continues to repeat these steps until the event/request that is received is a cancel event/request. After receiving the cancel event/request, the detailed single search query process for building a conflict-free travel itinerary 600 ends.

C. Travel Itinerary Event Triggering and Processing

FIG. 7 conceptually illustrates a reservation event request process 700 for reserving a travel itinerary in some embodiments. In some embodiments, the reservation event request process 700 includes detailed steps that relate to particular steps described by reference to FIG. 6 above, namely, triggering reservation event/request (at 642). As shown in this figure, the reservation event request process 700 for reserving a travel itinerary starts by receiving (at 710) an event/request to reserve the itinerary line item. The user may cancel out of this event/request by triggering a cancel event/request. Thus, when the process 700 determines (at 720) that there is a cancel event/request, then the reservation event request process 700 ends. Absent a cancel event/request, however, the reservation event request process 700 gets credentials (at 730), specifically, user credentials that allow the user to reserve the travel itinerary or travel itinerary item. Thus, the process 700 retrieves (at 740) the credentials. For example, the process 700 may retrieve the user's credentials from a user account database.

When the credentials are retrieved, the reservation event request process 700 then determines (at 750) whether appropriate credentials are available. For example, the user credentials may exist but may not satisfy a requirement for greater privileges in reserving travel itineraries. When appropriate credentials are not available, the process 700 outputs a message (760) to inform the user of the limited or non-existent credentials for reserving the travel itinerary or travel itinerary line item. Then the process 700 returns to 710 to receive an event/request to reserve the itinerary. On the other hand, when appropriate credentials are available, the reservation event request process 700 makes the reservation (at 770).

Next, the reservation event request process 700 determines (at 780) whether the reservation was successful. When the reservation is not successfully made, the reservation event request process 700 outputs a message (at 760) to inform the user that the reservation was not successfully completed. Then the reservation event request process 700 returns to 710 to receive an event/request to reserve the itinerary. On the other hand, when the reservation is successfully made, the reservation event request process 700 sends a confirmation (at 790) to the user. Then the reservation event request process 700 ends.

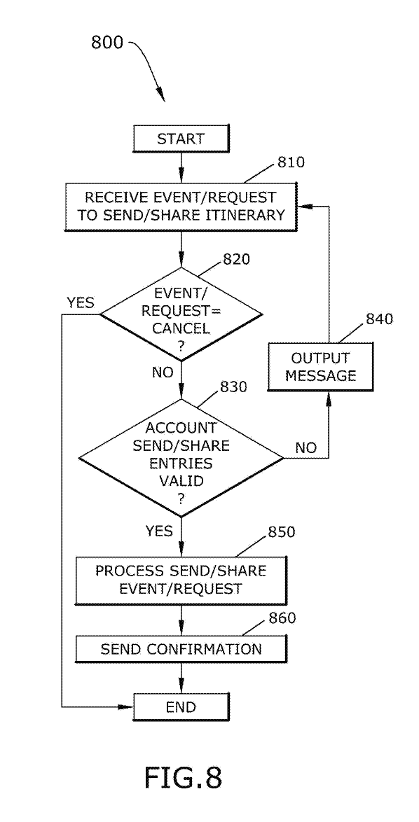

FIG. 8 conceptually illustrates a share/send event request process 800 for sending or sharing a travel itinerary in some embodiments. In some embodiments, the share/send event request process 800 for sending or sharing a travel itinerary includes detailed steps that relate to particular steps described by reference to FIG. 6 above, namely, triggering share event/request (at 644) and triggering send event/request (at 646). As shown in this figure, the share/send event request process 800 for sending or sharing a travel itinerary starts by receiving (at 810) an event/request to send or share the itinerary line item. The user may cancel out of this event/request by triggering a cancel event/request. Thus, when the process 800 determines (at 820) that there is a cancel event/request, then the share/send event request process 800 ends.

When there is no cancel event/request, however, the share/send event request process 800 determines (at 830) whether the account send/share entries are valid. When the account send/share entries are not valid, the share/send event request process 800 outputs a message (at 840) informing the user that the entries are invalid. For example, the user may specify an invalid email address (e.g., a typo in the spelling of the email address) to send the travel itinerary. On the other hand, when the account send/share entries are valid, the process 800 then processes (at 850) the send/share event/request. Finally, the process 800 sends a confirmation (at 860) to the user of the successfully sent or shared travel itinerary. Then the share/send event request process 800 ends.

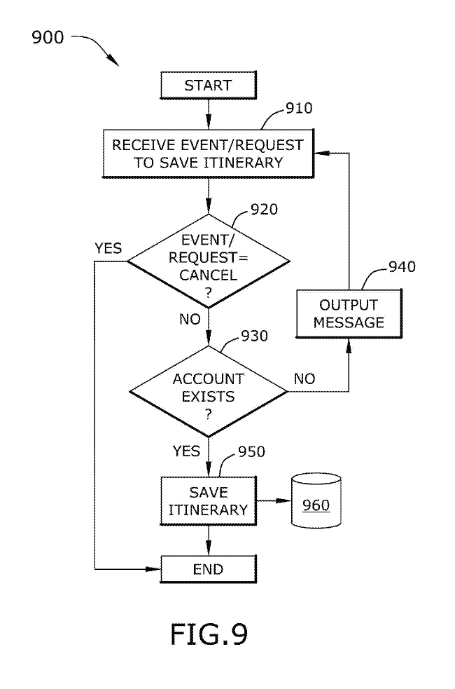

FIG. 9 conceptually illustrates a save event request process 900 for saving a travel itinerary in some embodiments. In some embodiments, the save event request process 900 for saving a travel itinerary includes detailed steps that relate to particular steps described by reference to FIG. 6 above, namely, triggering save event/request (at 648). As shown in this figure, the save event request process 900 for saving a travel itinerary starts by receiving (at 910) an event/request to save the itinerary line item. The user may cancel out of this event/request by triggering a cancel event/request. Thus, when the process 900 determines (at 920) that there is a cancel event/request, then the save event request process 900 ends.

When the process 900 determines that the event/request is not a cancel event/request, then the save operation can be completed. Thus, the save event request process 900 determines (at 930) whether an account exists for the user. For example, the user may not have logged in but still retrieved a generic travel itinerary and wanting to save the itinerary. When no account exists in relation to the user's selected travel itinerary (again, logging in without specific account credentials), then the process 900 outputs (at 940) a message informing the user that there is a lack of account information available to save the travel itinerary. On the other hand, when the account exists, the process 900 then saves (at 950) the travel itinerary. In some embodiments, the travel itinerary is saved in a travel itinerary database 960. After saving the travel itinerary, the process 900 ends.

D. Learning, Predicting, and Recommending Single Search Query Processes

In some embodiments, the travel concierge system is deployed as a cloud-network service in which a client computing device associated with a user connects to a server computing device that includes the travel concierge software application which implements a process for building a set of travel itineraries and outputting the travel itineraries to the client computing device for display on a display screen of the client computing device. In this way, a user who wishes to review travel itineraries in relation to an upcoming travel trip can easily review multiple itineraries from any location, including a home or work location (at an origin point of the trip), at the destination location (during the trip), or at another location remote from the trip origin and destination.

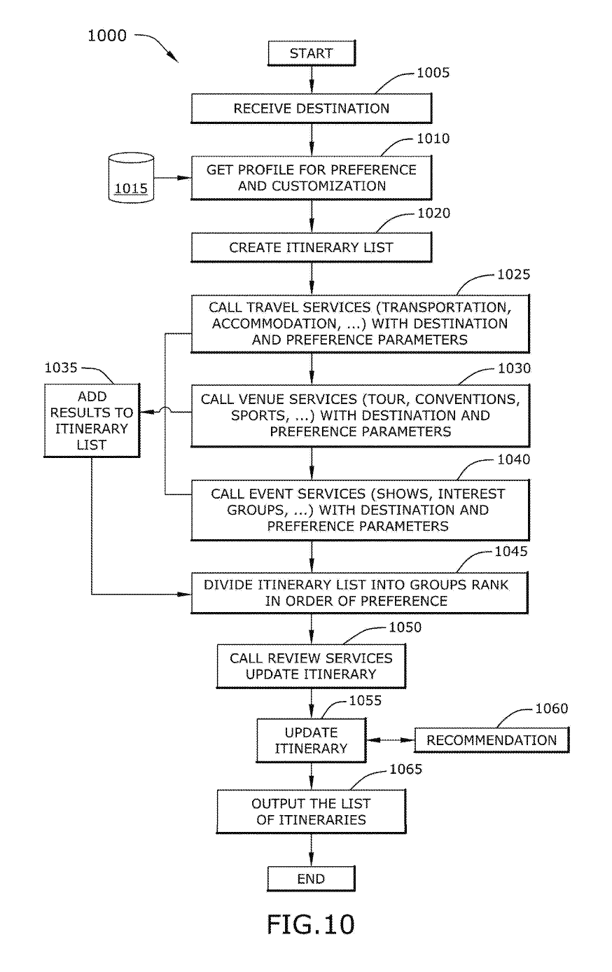

By way of example, FIG. 10 conceptually illustrates one such example of a detailed process for building a set of travel itineraries 1000 in some embodiments. As shown in this figure, the detailed process for building a set of travel itineraries 1000 starts by receiving (at 1005) a destination. As described above, the user may enter a variety of information in the single search box, including a zip code, a city name, a landmark, a telephone area code, etc., and the destination will be derived from the travel criteria provided. Similarly, the user can provide the travel criteria in a variety of different formats, including text, audio, video, and image formats, which subsequently trigger different parsers or processors to use in deriving the destination.

In some embodiments, the process 1000 gets (at 1010) a user profile for preference and customization details to use in building itineraries. In some embodiments, the process 1000 gets the user profile by retrieving the user profile from a user profile database 1015. After the user profile is retrieved, the process 1000 creates (at 1020) an itinerary list. In some embodiments, the itinerary list includes multiple organized travel-related resources. Examples of such travel-related resources include travel services (e.g., transportation, accommodation, etc.), venue services (e.g., tour, conventions, sports, etc.), and event services (e.g., shows, interest groups, etc.).

After the itinerary list is created, the detailed process for building a set of travel itineraries 1000 includes one or more of calling the travel services (at 1025) with destination and preference parameters, calling the venue services (at 1030) with destination and preference parameters, and calling the event services (at 1040) with destination and preference parameters. In some embodiments, the process 1000 determines which of the services (travel, venue, event) to call based on the itinerary list, user preferences, and the availability of options provided by way of each service. Whatever services are called and utilized, the process 1000 then adds the results (at 1035) to the itinerary list.

Next, the detailed process for building a set of travel itineraries 1000 divides (at 1045) the itinerary list into groups that are ranked in order of preference. For instance, the user may have specified a strong interest in taking tours of cities and only weak interest in sports-related venues to visit at a destination. Thus, the process 1000 organizes the travel itineraries first by dividing the list into groups based on ranked items as specified in the user's profile.

After dividing the itineraries into groups ranked in order of preference, the process 1000 then calls review services (at 1050) to update the itinerary. In some embodiments, the process 1000 updates the itinerary (at 1055) by retrieving recommendations (at 1060) from a recommendation service module. In some embodiments, the process 1000 also feeds the recommendation service module with information that allows the recommendation service module to derive recommendations and add them to a list of recommendations. In some embodiments, the recommendation service module operates a set of application programs that implement one or more learning algorithms. In this way, the recommendation service module “learns” about the recommendations that are sensible to make in relation to any given user.

After updating the itinerary list, the process 1000 outputs (at 1065) the list of itineraries. Then the detailed process for building a set of travel itineraries 1000 ends.

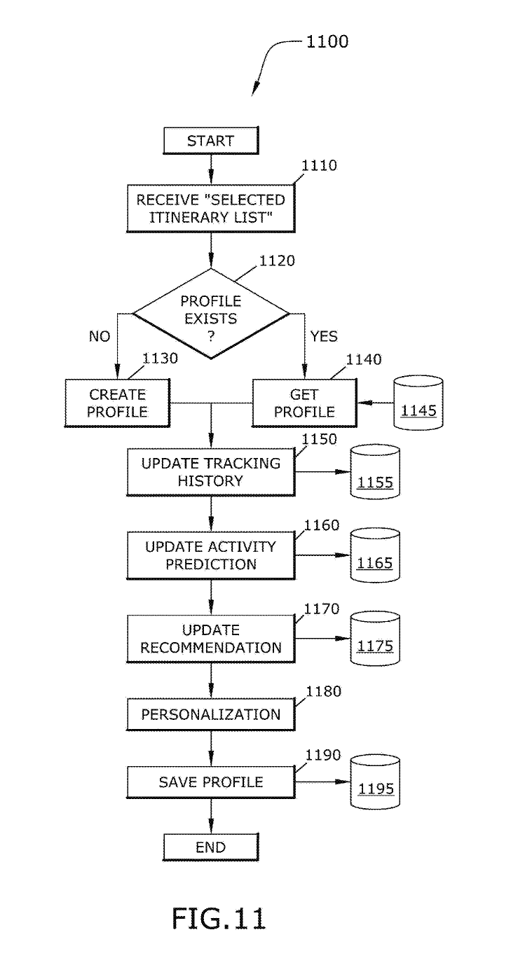

In another example, FIG. 11 conceptually illustrates a user preference learning and prediction process 1100 in some embodiments based on user interaction with a travel concierge system. The user preference learning and prediction process 1100 may be implemented as a computer program or software module, such as the recommendation service module which is integrated into the travel concierge software application.

In some embodiments, the user preference learning and prediction process 1100 starts by receiving (at 1110) a selected itinerary list. The selected itinerary list is a list of itinerary line items selected by the user, such as, for example, the selected list referenced at steps 530 and 560 of FIG. 5 or the selected list referenced at steps 630 and 660 of FIG. 6.

Next, the user preference learning and prediction process 1100 determines (at 1120) whether a profile exists. For instance, if the user is new to the system, there may not be a user profile established. Thus, the user preference learning and prediction process 1100 creates (at 1130) a user profile when no profile exists for the user. Alternatively, the user may be logged into the system and has a user profile with several saved travel preferences. In this case, the process 1100 retrieves (at 1140) the user profile. In some embodiments, the user profile is retrieved from a user profile database 1145.

Once the user profile is retrieved or created, the user preference learning and prediction process 1100 of some embodiments updates (at 1150) tracking history of the user with present tracking history data based on the user interactions and selections in relation to the travel itineraries. In some embodiments, the tracking data is stored in a tracking history database 1155.

Contemporaneously with updating the tracking history and storing the present tracking history data, in some embodiments, any previously stored existing tracking history data in the tracking history database is retrieved from the database to perform a set of organization and tabulating operations on all the tracking data (including the present tracking history data and the previously stored existing tracking history data) that allow for accurate activity prediction and recommendation processing. Thus, the user preference learning and prediction process 1100 updates (at 1160) activity prediction data associated with the user. In some embodiments, the activity prediction data is stored in an activity prediction database 1165. The process 1100 also updates (at 1170) recommendation information for the user. In some embodiments, recommendation data associated with the recommendation information is stored in recommendation database 1175.

Next, the user preference learning and prediction process 1100 of some embodiments performs personalization (at 1180) in relation to the user profile. The personalization is based on the activity prediction data and the recommendation information. In some embodiments, the process 1100 then saves (at 1190) the user profile. In some embodiments, the saved user profile is stored in a user profile database 1195. After saving the user profile, the process 1100 ends.

In some embodiments, the user profile database 1145 and the user profile database 1195 are the same database resource, with the exception of updated user profile data stored in the user profile database 1195. In some embodiments, the user preference learning and prediction process 1100 accesses a single database to store data updated during the steps of the process. In some embodiments, the single database comprises the user profile database 1145, the tracking history database 1155, the activity prediction database 1165, the recommendation database 1175, and the user profile database 1195

E. Third Party API Information Retrieval

Some aspects of the travel concierge system include retrieval of information from third party providers. Thus, the travel concierge software application may include sub-routines or modules which make application programming interface (API) calls to data sources associated with the third party providers. The API calls may be based on private APIs provided by the third party providers or publicly available APIs which are supported by one or more computer programming languages used to encode the travel concierge software application. Such private or publicly available APIs, therefore, include instruction sets of methods, procedures, functions, or data operation units which allow the travel concierge software application to request travel-related information and data that may be stored in one or more databases owned, administered, or otherwise available through the third party providers.

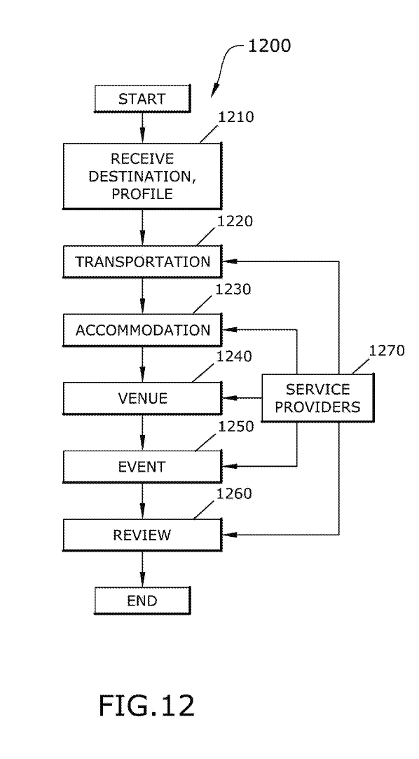

By way of example, FIG. 12 conceptually illustrates a process for retrieving travel-related information from third party providers by third party API calls 1200 in some embodiments. In some embodiments, the process 1200 starts by receiving (at 1210) the determined destination and the user profile. Next, the process 1200 engages with one or more third party data sources using one or more APIs to retrieve travel-related information that is relevant to the destination and consistent with settings and preferences specified in the user profile.

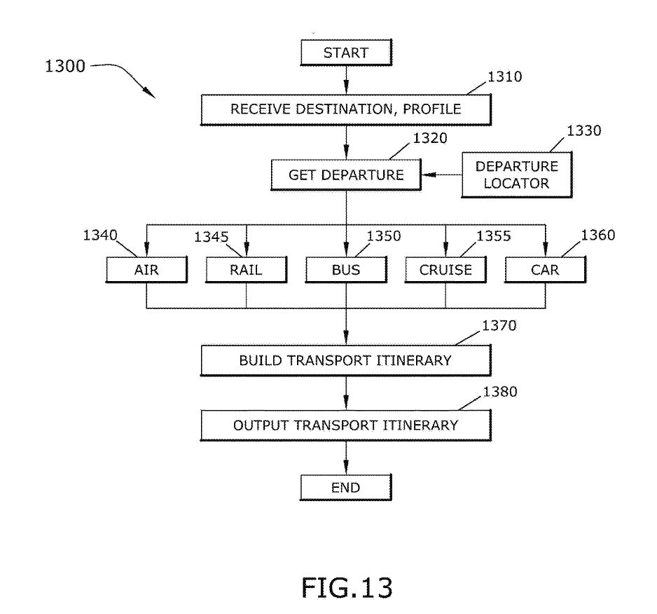

Specifically, the process 1200 retrieves transportation information (at 1220) by making API calls to retrieve transportation data from one or more transportation data sources which include transportation information related to the destination. The API calls are provided by or supported by service providers 1270, such as specific transportation providers. For example, the user may be traveling to Chicago so the process 1200 may determine whether there are any supported APIs associated with Chicago transportation providers, such as the Chicago Transit Authority (CTA), O'Hare Airport, and other transportation providers in and around Chicago, and thereafter make API calls to data sources associated with the Chicago transportation providers. Further details of retrieving transportation information by making API calls to retrieve transportation data from transportation data sources related to the destination are described below by reference to FIG. 13.

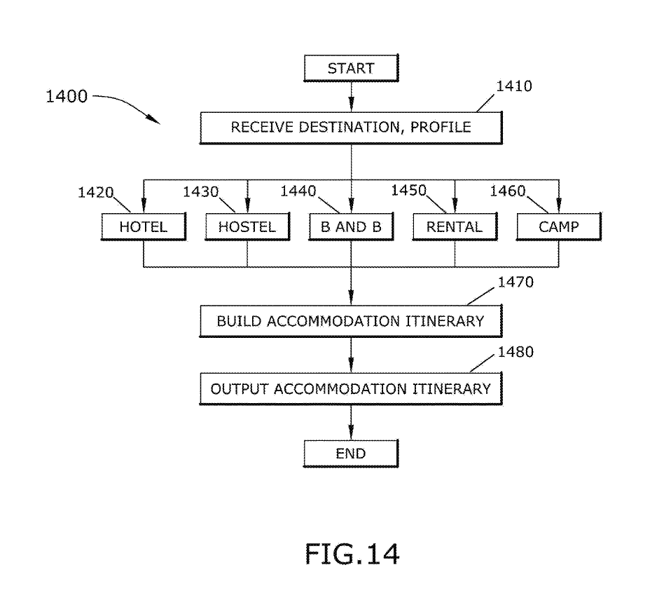

In some embodiments, the process for retrieving travel-related information from third party providers by third party API calls 1200 also retrieves accommodation information (at 1230) by making API calls to retrieve accommodation data from one or more accommodation data sources which include accommodation information related to the destination. For example, a hotel may provide room availability data and booking information by providing an API that allows hotel room availability to be searched and supports booking and reservations as directed by the user. Further details of retrieving accommodation information by making API calls to retrieve accommodation data from accommodation data sources related to the destination are described below by reference to FIG. 14.

The process 1200 further retrieves venue information (at 1240) by making API calls to retrieve venue-related data from one or more venue data sources which include venue information related to the destination. The process 1200 also retrieves event information (at 1250) via API calls to retrieve event data from event data sources related to the destination.

After third party information is retrieved in relation to the destination and in line with user preferences and settings specified in the user profile, the process 1200 of some embodiments then reviews (at 1260) the data retrieved and incorporates the data into the itineraries when relevant. Then the process for retrieving travel-related information from third party providers by third party API calls 1200 ends.

Turning now to FIG. 13, a transportation API call process 1300 of some embodiments is conceptually illustrated. In some embodiments, the transportation API call process 1300 starts by receiving (at 1310) the destination (as determined from the user-provided travel criteria) and the user profile. Next, the transportation API call process 1300 gets (at 1320) departure information. In some embodiments, the process 1300 requests departure information from a departure locator module 1330. When the departure is established, the process 1300 of some embodiments retrieves information relevant to the available modes of transportation at the destination. While the following example is non-exhaustive, it provides a sample of the types of transportation modes which can be tapped in relation to any travel trip and in building a travel itinerary. Thus, the process 1300 retrieves air transportation information (at 1340), rail transportation information (at 1345), bus transportation information (at 1350), cruise ship transportation information (at 1355), and car transportation information (at 1360).

After retrieving the relevant transportation information, the process 1300 of some embodiments builds (at 1370) a transportation itinerary. In some embodiments, a transportation itinerary is built for each destination in a trip. For example, the user may be traveling from Los Angeles to Chicago and then to New York and back to Los Angeles. In this example, the process 1300 would be performed for each destination in the trip, namely, for Chicago and for New York. Finally, the process 1300 outputs (1380) the transportation itinerary for inclusion in the overall travel itineraries presented to the user. Then the transportation API call process 1300 ends.

By way of another example, FIG. 14 conceptually illustrates an accommodation API call process 1400 in some embodiments. In some embodiments, the accommodation API call process 1400 starts by receiving (at 1410) the destination and the user profile. Next, the accommodation API call process 1400 retrieves information relevant to the available types of accommodation at the destination. While the following example is non-exhaustive, it provides a sample of the types of accommodation which can be searched for in relation to any travel trip and in building a travel itinerary. Thus, the process 1400 retrieves hotel information (at 1420), hostel information (at 1430), bed and breakfast (or “B and B”) information (at 1440), rental information (at 1450), and camping information (at 1460).

After retrieving the relevant accommodation information, the process 1400 of some embodiments builds (at 1470) an accommodation itinerary. In some embodiments, an accommodation itinerary is built for each destination in a trip (e.g., accommodations in Chicago and accommodations in New York). Finally, the process 1400 outputs (1480) the accommodation itinerary for inclusion in the overall travel itineraries presented to the user. Then the accommodation API call process 1400 ends.

F. Automated Machine-To-Machine Travel Itinerary Process

In some embodiments, an automated machine-to-machine (or electronic device to electronic device) travel itinerary process is a non-interactive automated travel concierge processing service program with no user interface for inputting travel criteria, but instead runs silently on a cloud server as a service to receive travel criteria. For example, a user may send a search query input file to the service when it is running on the cloud server of the travel concierge system. Alternatively, a computing device of the user can automatically send a search query input file to the cloud server-based service upon a trigger event (e.g. receive an email approving travel to a conference, or receive an email confirming a travel date to visit someone, etc.). In many cases, the non-user interface travel criteria provided by a user may take a digital format that is easy and quick to generate and send, such as an SMS text message or email. Also, an RSS feed may provide the travel criteria so that the automated travel concierge processing service program can identify travel destination(s) and build travel itineraries for the user to review.

In addition, the automated machine-to-machine travel itinerary process may accecpt non-specific travel criteria which does not explicitly name a city or region, but only avers to the travel destination city or region by some other information. For example, instead of naming the intended travel city, the travel criteria may include a telephone area code “808”, a landmark such as “Golden Gate Bridge”, a well-known phrase “Big Apple” or the name of a professional sports team “Cowboys”. In each case the travel concierge system will determine the city to be “Honolulu”, “San Francisco”, “New York” and “Dallas” respectively.

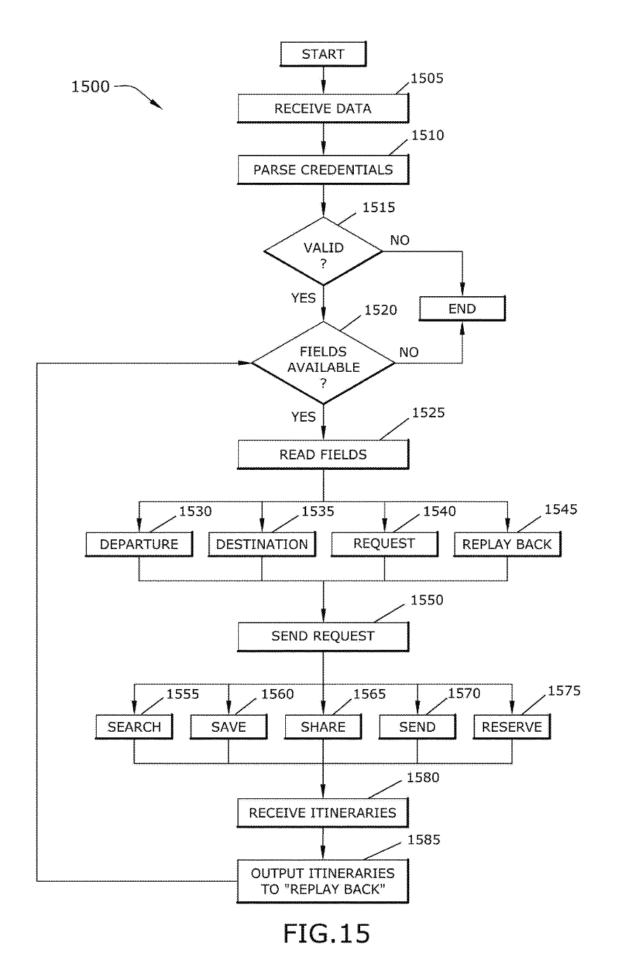

By way of example, FIG. 15 conceptually illustrates a non-interactive process 1500 for building a travel itinerary by way of a search query input file in some embodiments. The non-interactive process 1500 for building a travel itinerary by way of a search query input file is a machine-to-machine method involving communication from one computing device to another computing device. The input file can be a pre-formatted file or a simply a set of digital data. For instance, the input file may be text from a digital application that transmits text data input by the user to the service running on the cloud (e.g., SMS text message, RSS feed, etc.). In another example, a requesting machine may have a pre-formatted search query input file with a set of travel criteria data that allows a responding machine (such as a cloud server that runs a silent non-UI service) to automatically build one or more travel itineraries without user interaction. The non-interactive process 1500 may be implemented on such a responding machine (or responding computing device or cloud server) as a travel concierge software application or as a background travel criteria processing program service that runs silently on a processor of the responding machine (or responding computing device or cloud server) and receives a search query input file or digital data with with travel criteria data from a requesting machine (or requesting computing device). Alternatively, the non-interactive process 1500 may be integrated with another software application.

In some embodiments, a communication channel is used to transfer pre-formatted input data that can be used by the machines. For example, the requesting machine may send an email with the pre-formatted input data and the travel itinerary results would then be sent to the “reply” address or the “reply back” address. Another might be from SMS text message or RSS feed. This is useful for integration with other software applications.

In some embodiments, the non-interactive process 1500 for building a travel itinerary by way of a search query input file begins by receiving (at 1505) the search query input file with the travel criteria data. For example, the non-interactive process 1500 may be implemented to receive an SMS text message with the travel criteria information, an email with travel criteria entered in the subject line and/or the body of the email, or email with an attached search query input file that includes all of the travel criteria. Instead of digital data transmission via email, SMS text message, RSS feed, etc., the non-interactive process 1500 may be implemented to receive a direct upload (or rather, data transfer from the requesting machine received by the responding machine) of the search query input file. Another alternative includes file retrieval by the responding machine, such that when the non-interactive process 1500 receives a resource address, or rather, a universal resource locator (URL) address, the responding machine which implements the non-interactive process 1500 retrieves the search query input file from at the received URL.

In some embodiments, the non-interactive process 1500 parses (at 1510) the content of the search query input file. The content of the search query input file includes the travel criteria data. Thus, the non-interactive process 1500 determines (at 1515) whether the content of the search query input file includes valid travel criteria data. As noted above by reference to FIG. 2, the type of content is first determined and one or more data parsers is used according to the determined content type. In this way, the non-interactive process 1500 is able to determine whether the content of the search query input file is valid travel criteria data. When the content is determined to have valid travel criteria data, the non-interactive process 1500 determines the scope of the travel criteria data. This is described in further detail below. On the other hand, when the content is determined not to be valid travel criteria data, the non-interactive process 1500 ends.

In some embodiments, when the content of search query input file is determined to be valid, then the non-interactive process 1500 determines (at 1520) whether the content includes data that conforms to any travel fields. Unlike the interactive UI with the single search box and the plurality of entry fields of the travel concierge software application that implements the single search query process 100 described above by reference to FIG. 1, the non-interactive process 1500 parses the search query input file to obtain the travel criteria. The travel criteria data included with the search query input file may be as simple or as comprehensive as needed. For example, when the non-interactive process 1500 is implemented to accept email as the search query input file (e.g., receiving email sent to a specific email address), the email may include travel criteria data in any of several manners, such as a travel destination in the subject line but no data in the body of the email, a travel destination and other travel criteria formatted in the body of the email, or an attachment search query input file with travel criteria data entered in a specific format or template. In this way, the search query input file may include only basic travel criteria to search broadly for available travel itineraries (e.g., to the destination), or may be based on more specific travel needs which would otherwise be fleshed out by user selections in one or more fields. Such automated machine-to-machine processing is possible when pre-formatted input is provided by a requesting machine. For example, a pre-formatted search query input file may be a flat file (e.g., a text file) with source data, destination data, price range data, profile data, or other data formatted in a way that the responding machine would be able to extract the travel criteria data to build a set of travel itineraries and perform other travel related processing.

Thus, when the non-interactive process 1500 determines (at 1520) that the search query input file does not include travel criteria conforming to any of the fields, the non-interactive process 1500 ends. On the other hand, when the non-interactive process 1500 determines (at 1520) that the search query input file does include travel criteria data that conforms to the fields, the non-interactive process 1500 reads (at 1525) the data into the appropriate field. The non-interactive process 1500 shows several such fields, including departure 1530, destination 1535, request 1540, and replay back 1545. Other such field data may be included in other examples.

In some embodiments, the non-interactive process 1500 sends (at 1550) a request after the field travel criteria is read in from the search query input file. The request can be any request or combination of requests from several types of available requests, including requests to search 555, save 1560, share 1565, send 1570, and reserve 1575.

Next, the non-interactive process 1500 receives (at 1580) itineraries and then outputs (at 1585) the itineraries to “reply back” as provided (e.g., sending email with output itineraries to the user). The non-interactive process 1500 then returns to 1520 to determine if more field data is present in the search query input file. When no field data remains, the non-interactive process 1500 ends.

G. Personalization Process

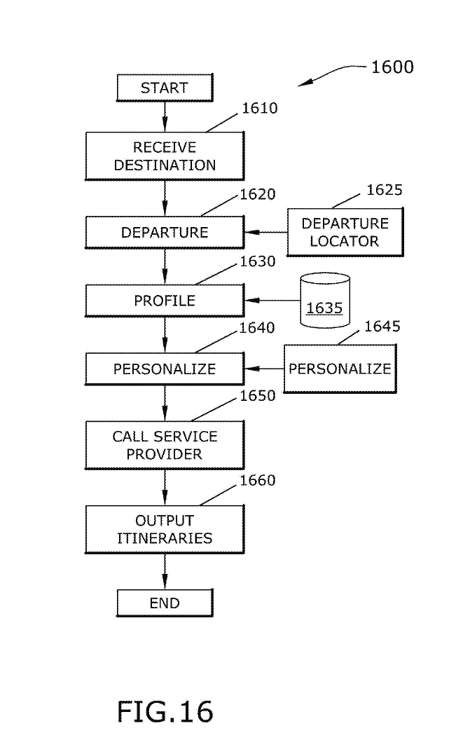

By way of example, FIG. 16 conceptually illustrates personalization process 1600 for personalizing travel itinerary settings in some embodiments. As shown in this figure, the personalization process 1600 starts by receiving a destination (at 1610) and a departure (at 1620). In some embodiments, the personalization process 1600 determines the departure by way of a departure locator 1625.

Next, the personalization process 1600 retrieves a profile (at 1630). The profile may be retrieved from a profile database 1635 or created new if no existing profile is present. The personalization process 1600 then personalizes (at 1640) the profile, either with currently provided personalization information, or by receiving personalization data 1645 as provided in a file or interactively. The personalization process 1600 then calls (at 1650) one or more service providers. For example, several service providers may be associated, including an airline service provider, local travel service providers, hotel accommodations, etc. Finally, the personalization process 1600 outputs (at 1660) one or more travel itineraries. Then the personalization process 1600 ends.

### II. Travel Concierge System

The travel concierge system of the present disclosure may be comprised of the following elements. This list of possible constituent elements is intended to be exemplary only and it is not intended that this list be used to limit the travel concierge system of the present application to just these elements. Persons having ordinary skill in the art relevant to the present disclosure may understand there to be equivalent elements that may be substituted within the present disclosure without changing the essential function or operation of the travel concierge system.

1. A network-accessible server computing device that provides a travel concierge service via a travel concierge application. In some embodiments, the travel concierge application includes a single search query module that accepts travel criteria for use in creating a single search query to search for travel-related items relevant to the travel criteria.

2. A recommendation engine (on the server computing device).

3. A travel itinerary personalization manager (on the server computing device).

4. A travel application programming interface (API) for travel-based searches, bookings, and reservations (displayed on client computing devices that use implement a single search query function of the travel concierge service and connect to the travel concierge service over the cloud network).

5. A set of social API search modules (run from the server computing device and connecting by API calls to specific travel and destination cloud databases and cloud services).

6. A set of travel itinerary and user profile databases.

7. A travel concierge travel application and user interface (UI) that is displayed on client computing devices to enable users to interact with the travel concierge system (the client computing devices connecting to the travel concierge service over the cloud network). In some embodiments, the travel concierge travel application receives instructions from the single search query module to display a single search query interface in the UI on a client computing device. In this way, a user can interact with the travel concierge service by inputting travel criteria in the single search query interface.

8. A set of internal parsers for text, image, voice, video, etc.

9. A module to service non-UI, non-interactive requests.

10. A processing unit to determine destination other than specific city name.

11. A free form itinerary generation engine that allows users to pick and choose their own itinerary from a potential list of itineraries.

In some embodiments, the system employs an internal personalization database and a recommendation process to build relevant itineraries for the user. The interface is structured to have a single entry field for the search for which the present invention's system would be able to derive a number of itineraries. The search query can contain the name of a location or the name of a city, county, state, the name of an event, a postal zip code, a telephone area code, the latitude and longitude, or a combination of the above.

In some embodiments, the system interacts with third-party services automatically via APIs without the need for the user to manually go to those sites and enter searches there. The user can enter one or just a few search terms and receive as output, an entire listing of possible itineraries they can choose from. The user can save, share, or book such itineraries immediately. If linked, the user can also automatically update their calendar and personal notes on services such as iCloud or similar services.

The following exemplary description of how the travel concierge system of the present disclosure works, includes a summary of one or more applications, modules, or other computer-implemented processes that are deployed and operate on one or more computing devices of the travel concierge system. In particular, the search query is dis-assembled into a service that will match the back-end functionality. For example, the user may input an area code of a phone number in the single search query interface (e.g., as a way to identify a destination), and the back-end processes of the system then identifies the area associated with the area code and finds one or more cities served by the area code, and if possible, performs one or more logical deduction steps to determine the most likely city as the destination (e.g., if the area code serves a large city with an airport and several smaller nearby cities, the system may deduce that the large city is the destination). Based on this preliminary step, the system then searches for travel-related items such as airlines, cars, hotels, places to visit, and other events in the destination city. When travel-related items are gathered, the system then builds one or more travel itineraries to present to the user for selection. The system then transmits data for the displaying the travel itineraries to the computing device of the user, which upon receiving the travel itinerary data displays them in the UI in a way that allows the user to select a specific itinerary.

For example, if the user schedules a trip to LA to see a hockey game, the system will suggest an itinerary for future trips, and suggest similar trips. The system's internal determination processes will add items to the list relevant to the user. The system can determine if this is a first visit or a repeat visit to the area. Based on this information, different venues of interest can be presented to the user. Users who regularly visits an area, a fixed itinerary can be saved by the system and used for future booking.

By way of example, FIG. 17 conceptually illustrates a detailed schematic view of an architecture of a travel concierge system 1700 which is accessed by a user of a client computing device to build a set of travel itineraries. As shown in this figure, the travel concierge system 1700 includes a plurality of client computing devices 1710a-1710n, a set of travel concierge servers 1720, and a user profile and itinerary database 1730. The set of travel concierge servers 1720 in some embodiments of the travel concierge system 1700 includes a web server front end for user registration and authentication, a recommendation engine, and a travel itinerary personalization manager. In some embodiments, the recommendation engine and the travel itinerary personalization manager are modules of the travel concierge service and provide enhanced travel itinerary processing in connection with travel criteria specified by users of the client computing devices 1710a-1710n to build personalized and/or recommended travel items or itineraries. The set of travel concierge servers 1720 is also connected to a data storage device that includes the user profile and itinerary database 1730.

In some embodiments, the user profile and itinerary database 1730 comprises a physical data storage device for persistent storage of data and a software database management application that provides methods to store and retrieve data, as well as secure all user profile information. In some embodiments, the user profile and itinerary database 1730 includes industry-standard cybersecurity measures to protect user profile information.

In some embodiments, one or more other databases (not shown) may be included in the travel concierge system 1700. For example, the travel concierge system may store landmark information associated with a set of known, famous landmarks, and which stores user-provided landmarks contemporaneously with typical usage of the travel concierge system. In some embodiments, users can submit a particular landmark for inclusion in the database. For example, a user may wish to include “Lambeau Field” as a landmark. Upon submitting this as a possible landmark, the travel concierge system may request associated information, such as relevant location (e.g., “Green Bay”, “Wisconsin”, etc.), nearby airports, etc. This is closely tied into the field of venue sub-processes in the aforementioned data entry process.

Another example of a database that may be included in the travel concierge system 1700 is a user history tracking and activity prediction database. This database may coincide with the user profile and itinerary database 1730, or may be a separate database with processes described above access to store profile-based itinerary determinations, variations in the recommended itineraries depending on whether or not a user is profiled, etc. For a profiled user, the search result will be more refined than a user with no profile. If the user does not have a profile, a generic itinerary is presented.

Each of the client computing devices 1710a, 1710b, 1710c, and 1710n connects to a web server of the set of travel concierge servers 1720 over a network (labeled “cloud network (Internet)” in this figure) to send and receive data (e.g., single search query travel criteria, travel itineraries, etc.). In some embodiments, the travel criteria and/or the itinerary data is temporarily stored in one or more databases (not shown) and/or folders on or connected to the set of travel concierge servers 1720. In some other embodiments, the set of travel concierge servers 1720 does not store any client's travel criteria and/or the itinerary data, but instead processes the travel criteria on-the-fly (in real-time) to build a set of travel itineraries. When the system 1700 works in real-time to process a client's travel criteria, travel field data, and/or user preference data, the set of travel concierge servers 1720 may generate copies of previously created itineraries that were saved or stored based on past searches and may modify the copied itineraries according to the travel criteria, travel field data, and/or user preference data presently received from the user. In some embodiments, the set of travel concierge servers 1720 generates multiple copies of itineraries to send to the requesting user and other associated users. For example, the requesting user may provide travel criteria using client computing device 1710a, and the travel concierge servers 1720 may send a set of travel itineraries back to the client computing device 1710a of the user, as well as to the user's manager via client computing device 1720, and the user's colleague via client computing device 1730. When multiple itineraries are generated and sent to multiple client computing devices, the travel concierge servers 1720 perform conflict check operations to ensure that all itineraries across all users are conflict free and are available to be reserved, booked, paid for, etc.

Additionally, the set of travel concierge servers 1720 can generate several travel itineraries in real-time. In some embodiments, each travel itinerary is generated in sequence, one after another. In some other embodiments in which the set of travel concierge servers 1720 includes multiple processors or software that is multi-threaded, multiple travel itineraries may be contemporaneously generated. The set of travel concierge servers 1720 of some embodiments may then transmit the generated travel itineraries back to the user (the user's client computing device) as a single package of several travel itineraries, which are unpacked by the client-side software application and displayed on the display screen of the user's client computing device.

The travel concierge system 1700 of the present disclosure generally works by user interaction with any of the client computing devices 1710a-1710n. Each client computing device 1710a-1710n runs a browser program or a proprietary client software application that connects to the server and initiates the travel itinerary process by entering travel criteria in the single search query field. In particular, the user will use the client computing device to interact with a graphical user interface (GUI) displayed in the browser or client software application. For example, the GUI may be a Java powered user interface located on the server and provided to the browser application or client software application for display on display screen of the client computing device. When the user provides the travel criteria for the single search query, the travel concierge servers 1720 first determine the type of content of the travel criteria (e.g., text, image, audio, video, etc.). Then, if the user has provided additional selections in the travel fields displayed in the GUI, the travel concierge servers 1720 process the corresponding travel criteria data.

The travel concierge system 1700 can determine if this is a user's first visit or a repeat visit to an area, based on user activity logging. Based on this information, the travel concierge system 1700 can present different venues of interest to the user. For a user who regularly visits an area, a fixed itinerary can be saved by the system and used for future booking.

For users without a profile, the travel concierge system 1700 can provide a generic itinerary list based on trending in the area of interest. The travel concierge system 1700 can retrieve such trending data from social media feeds or relevant public APIs. The current location of the user can be determined by the travel concierge system 1700 using HTML Geolocation API of the browser, with the user's permission, or read from the user profile. This includes geolocation of Google maps, for example, or the user's mobile device's GPS. The user can change his or her location in the profile at any time. The travel concierge system 1700 can also convert the user's IP address to location, address, or geolocation.

For the date entry in the search box, the travel concierge system 1700 will present a calendar to the user to select the date. When the entry in the search box is a date, multiple decision paths can occur. When the user has an account, the travel concierge system 1700 of some embodiments checks the user's profile to build an itinerary. For example, if the user travels regularly from LA to Dallas, a fixed or a non-fixed itinerary for the specified is built for the specified date. When the user has an account and has traveled to many destinations, then the travel concierge system 1700 of some embodiments builds an itinerary for all the destinations and presents the itineraries using an internal ranking.

In some embodiments, the travel concierge servers 1720 of the travel concierge system 1700 include a pre-configuration subsystem. In some embodiments, the pre-configuration subsystem performs both a fixed itinerary process and a dynamic query process. In the fixed itinerary process, the query can be pre-configured with a hint to use a fixed itinerary, such as the search term “Dallas fixed.” In this case, the travel concierge system 1700 knows that this is a user who travels from LA to Dallas, who likes to book his flight one day in advance, who typically flies business class on a specific commercial airline, who prefers to rent a full size car from Hertz, and who prefers to stay at a notable downtown hotel on a specific floor (e.g., always wants to stay on the 10th floor) and in a specific section (e.g., the east wing). The travel concierge system 1700 also knows that when in town, the user likes to go and see rodeos and eat at a particular barbecue restaurant located two blocks from the hotel. The travel concierge system 1700 also knows that his past visits lasted for three days, so the return flight back to LA is also booked.

Unlike fixed feature queries like “Golden Gate Bridge”, “French Quarter”, “Yellowstone”, “Niagara Falls”, “Pike Place”, some queries are dynamic, meaning they are based on events where the date and the place can change. For example, a query like “Golf tournament” can result in many groups of itineraries for every city which hosts a golf tournament. The dynamic query process handles such queries.

In some embodiments, the user profile and itinerary database 1730 stores users profiles created by a user profile creation process run on one or more of the travel concierge servers 1720. Every user will have a profile and the travel concierge system 1700 allows each user to create a login account where their future selection can be collected to personalize their travel experience. To build a user profile one or more of the travel concierge servers 1720 searches the user profile and itinerary database 1730 to identify patterns from the user's previous trips. Alternatively, social media data mining is performed, which is cross-referenced with the user's social media for profile creation.

In some embodiments, user registration and login and creation of profile may occur at the same time. The travel concierge system 1700 will allow logged-in users to choose whether to allow the travel concierge system 1700 to build a profile based on their social media accounts. If the user does not have a profile, then the travel concierge system 1700 will determine their location through network locating, latitude, longitude or other means and will present generic venues of interest in the vicinity to engage the user in more interaction with the travel concierge system 1700.

In some embodiments, the travel concierge system 1700 outputs the travel itineraries by displaying a list of groups, with multiple pages of search results. In some embodiments, the travel concierge system 1700 presents a group of itineraries to the user based on an internal ranking system, with the most relevant as the first group and continuing down with other groups of itineraries that have a lower ranking.

When travel itineraries are generated and output for user display, the travel concierge servers 1720 of some embodiments also run recommendation services that enhance the travel itineraries with commercial product or service details and advertisements. For example, local restaurants at the destination may advertise to users who are traveling and who fit a food profile associated with such restaurants (e.g., vegetarians receiving recommendations of vegetarian restaurants, etc.).

The travel concierge system is versatile enough to build a travel itinerary based on any travel-related search data provided by the user via the single search query interface. For instance, the user may input one or more of the following: city, postal zip code, telephone area code, geo-coordinates, etc. Furthermore, the travel concierge system may be deployed as a cloud-network web service, as an in-house private network application (e.g., for a company), or may operate at the client site by integration with one or more other software applications.

The above-described embodiments of the invention are presented for purposes of illustration and not of limitation.

### III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

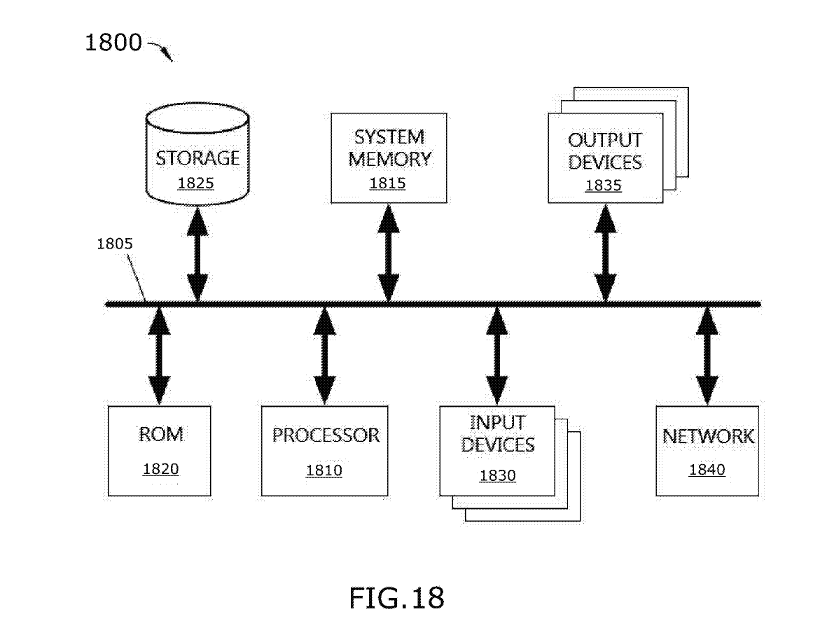

FIG. 18 conceptually illustrates an electronic system 1800 with which some embodiments of the invention are implemented. The electronic system 1800 may be a computer, phone, PDA, or any other sort of electronic device. Such an electronic system includes various types of computer readable media and interfaces for various other types of computer readable media. Electronic system 1800 includes a bus 1805, processing unit(s) 1810, a system memory 1815, a read-only 1820, a permanent storage device 1825, input devices 1830, output devices 1835, and a network 1840.

The bus 1805 collectively represents all system, peripheral, and chipset buses that communicatively connect the numerous internal devices of the electronic system 1800. For instance, the bus 1805 communicatively connects the processing unit(s) 1810 with the read-only 1820, the system memory 1815, and the permanent storage device 1825.

From these various memory units, the processing unit(s) 1810 retrieves instructions to execute and data to process in order to execute the processes of the invention. The processing unit(s) may be a single processor or a multi-core processor in different embodiments.

The read-only-memory (ROM) 1820 stores static data and instructions that are needed by the processing unit(s) 1810 and other modules of the electronic system. The permanent storage device 1825, on the other hand, is a read-and-write memory device. This device is a non-volatile memory unit that stores instructions and data even when the electronic system 1800 is off. Some embodiments of the invention use a mass-storage device (such as a magnetic or optical disk and its corresponding disk drive) as the permanent storage device 1825.

Other embodiments use a removable storage device (such as a floppy disk or a flash drive) as the permanent storage device 1825. Like the permanent storage device 1825, the system memory 1815 is a read-and-write memory device. However, unlike storage device 1825, the system memory 1815 is a volatile read-and-write memory, such as a random access memory. The system memory 1815 stores some of the instructions and data that the processor needs at runtime. In some embodiments, the invention's processes are stored in the system memory 1815, the permanent storage device 1825, and/or the read-only 1820. For example, the various memory units include instructions for processing appearance alterations of displayable characters in accordance with some embodiments. From these various memory units, the processing unit(s) 1810 retrieves instructions to execute and data to process in order to execute the processes of some embodiments.

The bus 1805 also connects to the input and output devices 1830 and 1835. The input devices enable the user to communicate information and select commands to the electronic system. The input devices 1830 include alphanumeric keyboards and pointing devices (also called “cursor control devices”). The output devices 1835 display images generated by the electronic system 1800. The output devices 1835 include printers and display devices, such as cathode ray tubes (CRT) or liquid crystal displays (LCD). Some embodiments include devices such as a touchscreen that functions as both input and output devices.

Finally, as shown in FIG. 18, bus 1805 also couples electronic system 1800 to a network 1840 through a network adapter (not shown). In this manner, the computer can be a part of a network of computers (such as a local area network (“LAN”), a wide area network (“WAN”), or an intranet), or a network of networks (such as the Internet). Any or all components of electronic system 1800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 4 and 6 conceptually illustrate processes. The specific operations of these processes may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a travel concierge program which, when executed by a processor of a computing device, creates a set of travel itineraries, said travel concierge program comprising sets of instructions for:
receiving a single search query comprising travel criteria associated with a travel destination;
determining the travel destination based on the travel criteria;
creating a set of travel itineraries for travel to and from the determined travel destination; and
providing the set of travel itineraries to a user planning to travel to the destination.

2. The non-transitory computer readable medium of claim 1, wherein the travel concierge program further comprises a set of instructions for determining a format of the travel criteria.

3. The non-transitory computer readable medium of claim 2, wherein the format of the travel criteria is at least one of textual data, image data, audio data, and video data.

4. The non-transitory computer readable medium of claim 3, wherein the travel concierge program further comprises a set of instructions for parsing the travel criteria according to the determined format of the travel criteria.

5. The non-transitory computer readable medium of claim 1, wherein the travel concierge program further comprises a set of instructions for determining whether an a user profile associated with the user exists.

6. The non-transitory computer readable medium of claim 5, wherein the set of instructions for creating the set of travel itineraries for travel to and from the determined travel destination comprises sets of instructions for:
generating a set of generic travel itineraries when no user profile exists; and
generating a set of personalized travel itineraries when a user profile exists for the user.

7. The non-transitory computer readable medium of claim 1, wherein the travel concierge program further comprises sets of instructions for:
receiving an event request; and
processing the event request.

8. The non-transitory computer readable medium of claim 7, wherein the set of instructions for processing the event request comprises sets of instructions for:
ending event request processing for the received event request when the received event request is a cancel event request; and
performing the event request when the received event request is not a cancel event request.

9. The non-transitory computer readable medium of claim 1, wherein the set of instructions for receiving the single search query comprises a set of instructions for receiving a text message comprising textual travel criteria associated with a travel destination, wherein the computing device is a cloud server computer and the processor is a cloud server processing unit, wherein the travel concierge program comprises an automated travel concierge processing service program that runs silently without a user interface on the cloud server processing unit to receive travel criteria in text message format.

10. The non-transitory computer readable medium of claim 9, wherein the sets of instructions for performing the event request comprises sets of instructions of at least one of reserving a travel itinerary item associated with the received event request, sharing the travel itinerary item associated with the received event request with at least one other user, sending the travel itinerary item associated with the received event request to a user, and saving the travel itinerary item associated with the received event request.
